(19) United States
(12) Patent Application Publication
(10) Pub. No.: US 2018/0376251 A1
(43) Pub. Date: Dec. 27, 2018

(54) ELECTRO-ACOUSTIC TRANSDUCER

(71) Applicant: GlobalMEMS Co., Ltd., Grand Cayman (KY)

(72) Inventors: Shih-Hsiung Tseng, New Taipei City (TW); Ming-Ching Wu, Taoyuan City (TW)

(73) Assignee: GlobalMEMS Co., Ltd., Grand Cayman (KY)

(21) Appl. No.: 15/662,299

(22) Filed: Jul. 28, 2017

(30) Foreign Application Priority Data
Jun. 23, 2017 (TW) 106120999

(51) Int. Cl. H04R 17/00; H04R 7/06

(52) U.S. Cl. CPC H04R 17/00; H04R 7/06

(57) ABSTRACT

An electro-acoustic transducer includes a base and at least a vibration portion. The vibration portion includes a piezoelectric transducer layer and is connected to the base. The piezoelectric transducer layer includes an upper electrode layer and a piezoelectric material layer. The piezoelectric material layer has a first zone and a second zone, wherein at least a part of the upper electrode layer is disposed in the first zone, and the piezoelectric material layer has a plurality of first holes in the second zone. The piezoelectric transducer layer is adapted to receive an electrical signal to deform, such that the vibration portion is driven to vibrate and generate a corresponding acoustic wave. The vibration portion is adapted to receive an acoustic wave to vibrate, such that the piezoelectric transducer layer is driven to deform and generate a corresponding electrical signal.

### CROSS-REFERENCE TO RELATED APPLICATION

This application claims the priority benefit of Taiwan application serial no. 106120999, filed on Jun. 23, 2017. The entirety of the above-mentioned patent application is hereby incorporated by reference herein and made a part of this specification.

### BACKGROUND OF THE INVENTION

### Field of the Invention

The invention relates to an electro-acoustic transducer and more particularly relates to a piezoelectric electro-acoustic transducer.

### Description of Related Art

An electro-acoustic transducer may be used in a sound input device such as a microphone, and may also be used in a sound output device such as a speaker. In the case of a piezoelectric electro-acoustic transducer, an electrical signal is applied to the upper and lower electrodes of a piezoelectric material to deform the piezoelectric material by the piezoelectric effect of the piezoelectric material, and thereby drive the corresponding vibration film to vibrate so as to generate a corresponding acoustic wave. On the other hand, an acoustic wave may also be applied to the vibration film to vibrate and deform the corresponding piezoelectric material so as to utilize the piezoelectric effect of the piezoelectric material to generate a corresponding electrical signal.

Consumer electronics, such as smart phones, notebook computers, tablet PCs, and so on, are generally equipped with microphones and speakers. In order to meet the demand for high-quality and versatile consumer electronics and to be more competitive in the market, manufacturers all desire to use advanced technology to develop and manufacture electro-acoustic transducers for use in the microphones and speakers. Therefore, how to effectively improve the electro-acoustic transduction efficiency for sound input/output devices remains an important issue in the field of development of electro-acoustic transducer.

### SUMMARY OF THE INVENTION

The invention provides an electro-acoustic transducer that has favorable electro-acoustic transduction quality.

The electro-acoustic transducer of the invention includes a base and at least a vibration portion. The vibration portion includes a piezoelectric transducer layer and is connected to the base. The piezoelectric transducer layer includes an upper electrode layer and a piezoelectric material layer. The piezoelectric material layer includes a first zone and a second zone. At least a part of the upper electrode layer is disposed in the first zone, and the piezoelectric material layer has a plurality of first holes in the second zone. The piezoelectric transducer layer is adapted to receive an electrical signal to deform and drive the vibration portion to vibrate and generate a corresponding acoustic wave, and the vibration portion is adapted to receive an acoustic wave to vibrate and drive the piezoelectric transducer layer to deform and generate a corresponding electrical signal.

In an embodiment of the invention, each of the first holes penetrates the piezoelectric material layer.

In an embodiment of the invention, the second zone is formed into a mesh structure by the first holes.

In an embodiment of the invention, the piezoelectric material layer further has a plurality of second holes at a boundary between each vibration portion and the base, and the first zone is located between the first holes and the second holes.

In an embodiment of the invention, each of the second holes penetrates the piezoelectric material layer.

In an embodiment of the invention, the number of the at least a vibration portion is plural, and each of the vibration portions includes two connection ends and a free end. The connection ends are connected to the base and the free ends are separated from one another.

In an embodiment of the invention, the base has an opening, and the vibration portions are located in the opening and the connection ends are connected to an inner edge of the opening.

In an embodiment of the invention, a notch is formed between each of the vibration portions and the inner edge of the opening, and the notch is located between the two connection ends.

In an embodiment of the invention, the base includes a plurality of extension portions, and the extension portions are connected to the inner edge of the opening and are respectively aligned with the notches and separated from the vibration portions.

In an embodiment of the invention, the upper electrode layer is aligned with the connection end, and the first holes are aligned with the free end.

In an embodiment of the invention, the electro-acoustic transducer further includes a connection portion. The number of the at least a vibration portion is plural, and each of the vibration portions includes a first connection end and a second connection end that are opposite to each other. The first connection ends are connected to the base, and the connection portion is separated from the base and connected to the second connection ends.

In an embodiment of the invention, the base has an opening, and the vibration portions and the connection portion are located in the opening, and the first connection ends are connected to an inner edge of the opening.

In an embodiment of the invention, the vibration portions surround the connection portion.

In an embodiment of the invention, the upper electrode layer includes a first electrode zone and a second electrode zone that are separated from each other, the first electrode zone is aligned with the first connection end and is located in the first zone, the second electrode zone is aligned with the second connection end and the connection portion and is surrounded by the second zone, and the first holes are located between the first electrode zone and the second electrode zone.

In an embodiment of the invention, the first electrode zone is adapted to receive or output an electrical signal and the second electrode zone is adapted to receive or output another electrical signal, and the two electrical signals have opposite phases.

In an embodiment of the invention, the vibration portion further includes a carrier layer, and the piezoelectric transducer layer is disposed on the carrier layer. The piezoelectric transducer layer is adapted to deform relative to the carrier layer to drive the vibration portion to vibrate, and the vibration portion is adapted to vibrate and drive the piezoelectric transducer layer to deform relative to the carrier layer.

In an embodiment of the invention, a material of the carrier layer is a non-piezoelectric material.

In an embodiment of the invention, the piezoelectric transducer layer further includes a lower electrode layer, and the piezoelectric material layer is disposed between the upper electrode layer and the lower electrode layer.

Based on the above, in the electro-acoustic transducer of the invention, the piezoelectric material layer has a plurality of first holes and the vibration portion may release the residual stress by the first holes to prevent the vibration portion from being unexpectedly permanently deformed and thereby improve the electro-acoustic transduction quality of the electro-acoustic transducer. Moreover, by forming the first holes in the piezoelectric material layer, the weight of the vibration portion may be reduced to increase the amplitude of vibration so as to improve the sensitivity of electro-acoustic transduction. Because the first holes of the piezoelectric material layer are formed in the second zone, instead of the first zone where the upper electrode layer is located, during vibration of the vibration portion, the stress change of the piezoelectric material layer in the first zone is not affected by the first holes, and thus the expected piezoelectric transduction effect is achieved.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic top view of an electro-acoustic transducer according to an embodiment of the invention.

FIG. 2A is a schematic cross-sectional view, taken along the line I-I′, of the electro-acoustic transducer of FIG. 1.

FIG. 2B illustrates that a bottom portion of a base 110 of FIG. 2A is unexpectedly over-etched.

FIG. 3 is a schematic top view of an electro-acoustic transducer according to another embodiment of the invention.

FIG. 4 is a schematic top view of an electro-acoustic transducer according to another embodiment of the invention.

FIG. 5 is a schematic cross-sectional view, taken along the line I-I′, of the electro-acoustic transducer of FIG. 4.

FIG. 6 is a schematic top view of an electro-acoustic transducer according to another embodiment of the invention.

FIG. 7A to FIG. 7D are schematic views illustrating a manufacturing process of the electro-acoustic transducer of FIG. 1.

### DESCRIPTION OF THE EMBODIMENTS

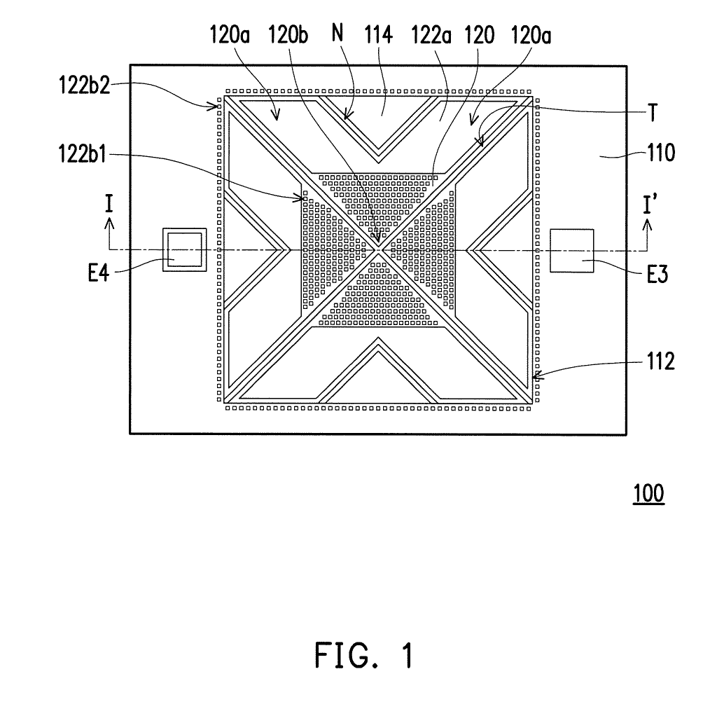

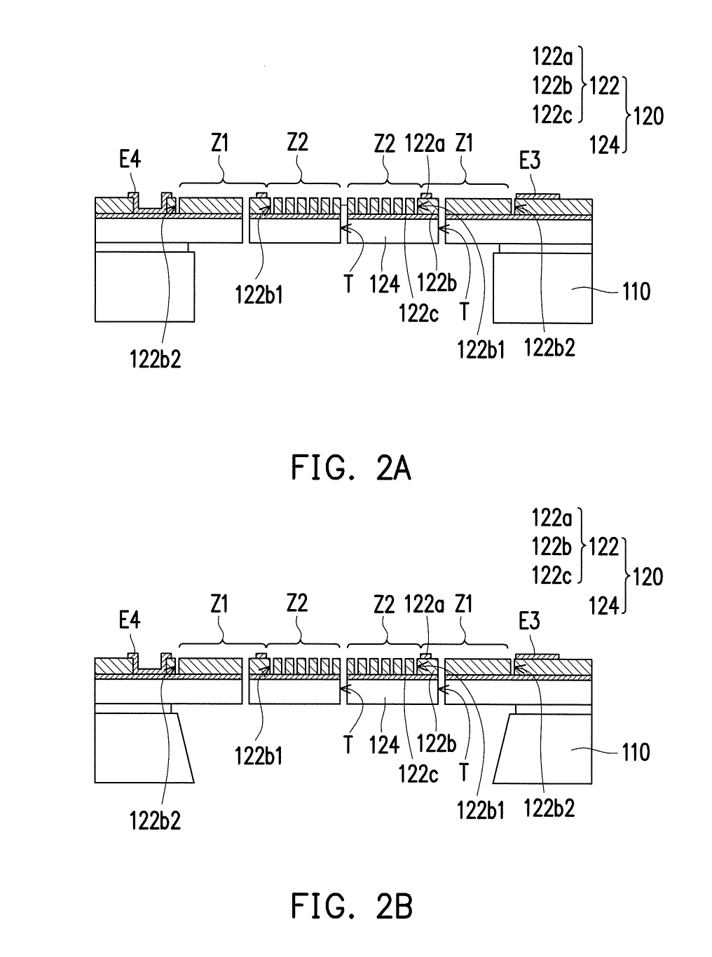

FIG. 1 is a schematic top view of an electro-acoustic transducer according to an embodiment of the invention. FIG. 2A is a schematic cross-sectional view, taken along the line I-I′, of the electro-acoustic transducer of FIG. 1. Referring to FIG. 1 and FIG. 2A, an electro-acoustic transducer 100 of this embodiment is manufactured by a MEMS (Microelectromechanical Systems) process, for example, and may be applied to a sound input device (e.g., a microphone), a sound output device (e.g., a speaker), or an ultrasound transducer. The electro-acoustic transducer 100 includes a base 110 and a plurality of vibration portions 120 (four are illustrated). Each vibration portion 120 includes a piezoelectric transducer layer 122 (shown in FIG. 2A). The piezoelectric transducer layers 122 are adapted to receive an electrical signal to deform so as to drive the vibration portions 120 to vibrate and generate a corresponding acoustic wave. In addition, the vibration portions 120 are adapted to receive an acoustic wave to vibrate so as to drive the piezoelectric transducer layers 122 to deform and generate a corresponding electrical signal.

In this embodiment, the piezoelectric transducer layer 122 includes an upper electrode layer 122a and a piezoelectric material layer 122b. The piezoelectric material layer 122b has a first zone Z1 (shown in FIG. 2) and a second zone Z2 (shown in FIG. 2). The upper electrode layer 122a is disposed in the first zone Z1, and the piezoelectric material layer 122b has a plurality of first holes 122b1 in the second zone Z2. Thus, the vibration portions 120 may release residual stress by the first holes 122b1 to prevent the vibration portions 120 from being unexpectedly permanently deformed and thereby improve the electro-acoustic transduction quality of the electro-acoustic transducer 100. Moreover, by forming the first holes 122b1 in the piezoelectric material layer 122b, the weight of the vibration portions 120 may be reduced to increase the amplitude of vibration so as to improve the sensitivity of electro-acoustic transduction. Because the first holes 122b1 of the piezoelectric material layer 122b are formed in the second zone Z2, instead of the first zone Z1 where the upper electrode layer 122a is located, during vibration of the vibration portions 120, the stress change of the piezoelectric material layer 122b in the first zone Z1 is not affected by the first holes 122b1, and thus the expected piezoelectric transduction effect is achieved.

In this embodiment, the second zone Z2 of the piezoelectric material layer 122b is formed into a mesh structure due to the first holes 122b1, for example. In addition, the piezoelectric material layer 122b further has a plurality of second holes 122b2 at a boundary between each vibration portion 120 and the base 110. The first zone Z1 is located between the first holes 122b1 and the second holes 122b2. Thus, the outermost ones of the first holes 122b1 and the second holes 122b2 form a boundary of the first zone Z1 and structurally define the first zone Z1 as a stress zone, such that each vibration portion 120 may be expected to perform piezoelectric transduction by the first zone Z1 and the upper electrode layer 122a thereon during vibration. FIG. 2B illustrates that a bottom portion of the base 110 of FIG. 2A is unexpectedly over-etched. More specifically, if the bottom portion of the base 110 is over-etched, as shown in FIG. 2B, and causes the boundary of the vibration portion 120 to be expanded unexpectedly, the first holes 122b1 and the second holes 122b2 that define the boundary of the first zone Z1 may maintain the range of the stress zone and prevent the over etching of the bottom portion of the base 110 from expanding the stress zone.

In this embodiment, the first holes 122b1 and the second holes 122b2 all penetrate the piezoelectric material layer 122b so as to achieve better stress release and weight reduction. Nevertheless, the invention is not limited thereto. In other embodiments, the first holes 122b1 may not penetrate the piezoelectric material layer 122b and the second holes 122b2 may not penetrate the piezoelectric material layer 122b.

In this embodiment, each vibration portion 120 has two connection ends 120a and a free end 120b. The connection ends 120a are connected to the base 110, and the free ends 120b are separated from one another. With this configuration, after the integral base 110 and vibration portions 120 are manufactured, an unexpected internal stress of the overall structure may be released by the free end 120b. Thus, when an electrical signal is inputted to the piezoelectric transducer layer 122 to drive the vibration portion 120 to vibrate and generate a corresponding acoustic wave, the accuracy of output of the acoustic wave is not affected by the internal stress. Furthermore, when the vibration portion 120 receives an acoustic wave to drive the piezoelectric transducer layer 122 to deform and generate a corresponding electrical signal, the accuracy of output of the electrical signal is not affected by the internal stress.

Accordingly, the electro-acoustic transducer 100 has favorable electro-acoustic transduction quality.

In this embodiment, the base 110 has an opening 112, as shown in FIG. 1, and the vibration portions 120 are located in the opening 112, and the connection ends 120a are connected to an inner edge of the opening 112. A notch N is formed between each vibration portion 120 and the inner edge of the opening 112. The notch N is located between the two connection ends 120a, such that the vibration portion 120 becomes a vibration structure supported at two ends, i.e., the two connection ends 120a that are separated from each other. The base 110 has a plurality of extension portions 114 (four are illustrated). The extension portions 114 are connected to the inner edge of the opening 112, and are respectively aligned with the notches N and separated from the vibration portions 120. The extension portions 114 cover the notch N between the two connection ends 120a so as to prevent the acoustic wave from being lost via the notch N.

Moreover, each vibration portion 120 of this embodiment further includes a carrier layer 124, as shown in FIG. 2. The piezoelectric transducer layer 122 is disposed on the carrier layer 124. The piezoelectric transducer layer 122 is adapted to receive an electrical signal and stretch and deform relative to the carrier layer 124 to drive the vibration portion 120 to vibrate, and the vibration portion 120 is adapted to receive an acoustic wave to vibrate so as to drive the piezoelectric transducer layer 122 to stretch and deform relative to the carrier layer 124, and thereby enable the piezoelectric transducer layer 122 to generate an electrical signal. The carrier layer 124 may be a device layer in the form of silicon on insulator (SOI) or be composed of other suitable non-piezoelectric materials. Nevertheless, the invention is not limited thereto.

The base 110 may be a handle layer in the form of silicon on insulator (SOI) or be composed of other suitable materials. Nevertheless, the invention is not limited thereto.

More specifically, each piezoelectric transducer layer 122 of this embodiment further includes a lower electrode layer 122c, and the piezoelectric material layer 122b is disposed between the upper electrode 122a and the lower electrode layer 122c. A material of the upper electrode layer 122a is Au, for example, but not limited thereto. The upper electrode layer 122a is aligned with the connection end 120a and the first holes 122b1 are aligned with the free end 120b. A material of the lower electrode layer 122c is Pt, for example, but not limited thereto. In addition, the upper electrode layer 122a and the lower electrode layer 122c further extend to the base 110 and have an electrode E3 and an electrode E4 respectively at the base 110. The electro-acoustic transducer 100 may input or output an electrical signal via the upper electrode layer 122a, the electrode E3 of the upper electrode layer 122a, and the electrode E4 of the lower electrode layer 122c.

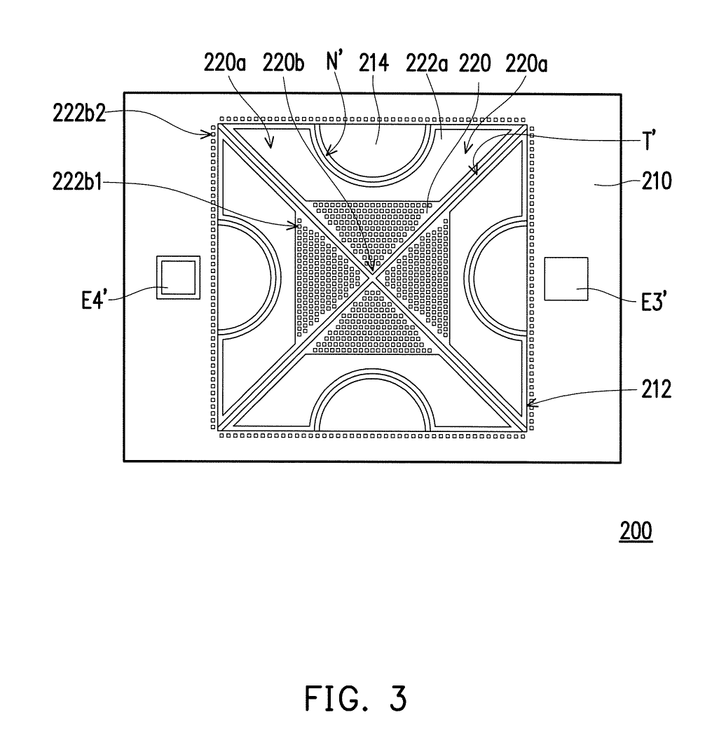

FIG. 3 is a schematic top view of an electro-acoustic transducer according to another embodiment of the invention. In an electro-acoustic transducer 200 of FIG. 3, a base 210, an opening 212, an extension portion 214, a vibration portion 220, a connection end 220a, a free end 220b, an upper electrode layer 222a, a first hole 222b1, a second hole 222b2, an electrode E3′, an electrode E4′, a notch N′, and a trench T′ are configured and function similar to the base 110, the opening 112, the extension portion 114, the vibration portion 120, the connection end 120a, the free end 120b, the upper electrode layer 122a, the first hole 122b1, the second hole 122b2, the electrode E3, the electrode E4, the notch N, and the trench T of FIG. 1 and thus details thereof are not repeated hereinafter. A difference between the electro-acoustic transducer 200 and the electro-acoustic transducer 100 is that the notch N′ and the extension portion 214 are semi-circular rather than triangular as shown in FIG. 1. In other embodiments, the notch and the extension portion may also have other suitable shapes. The invention is not intended to limit the shapes of these portions.

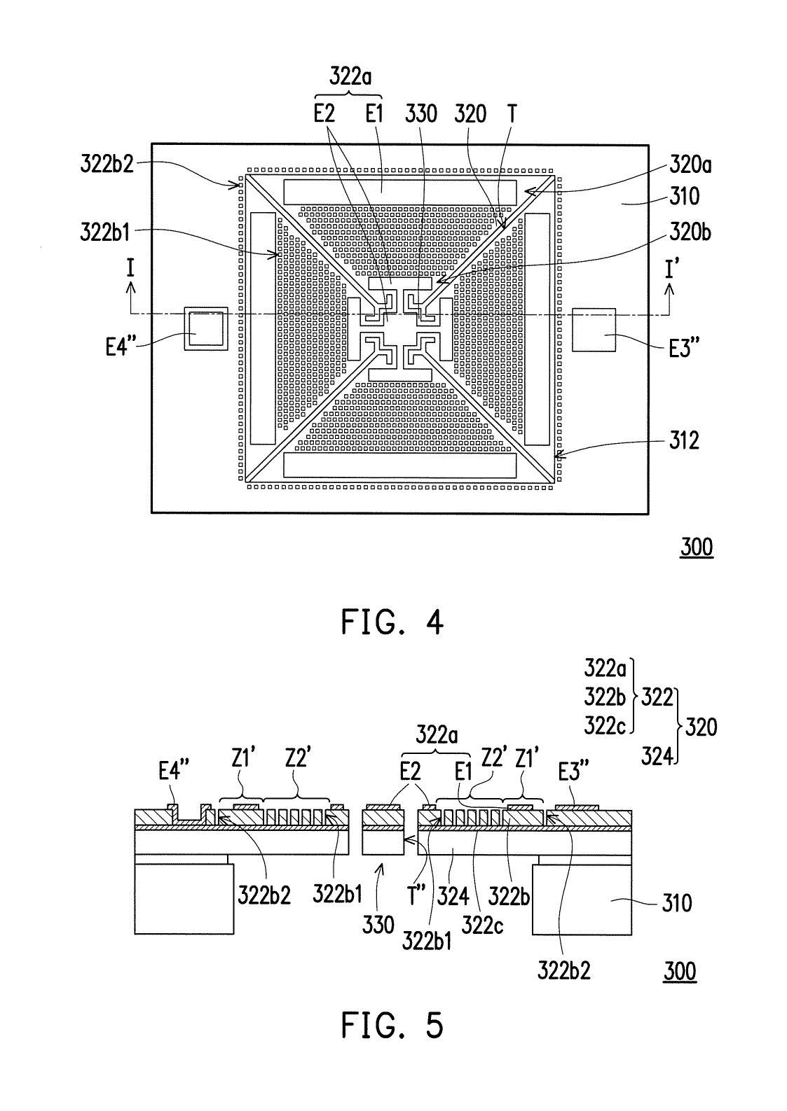

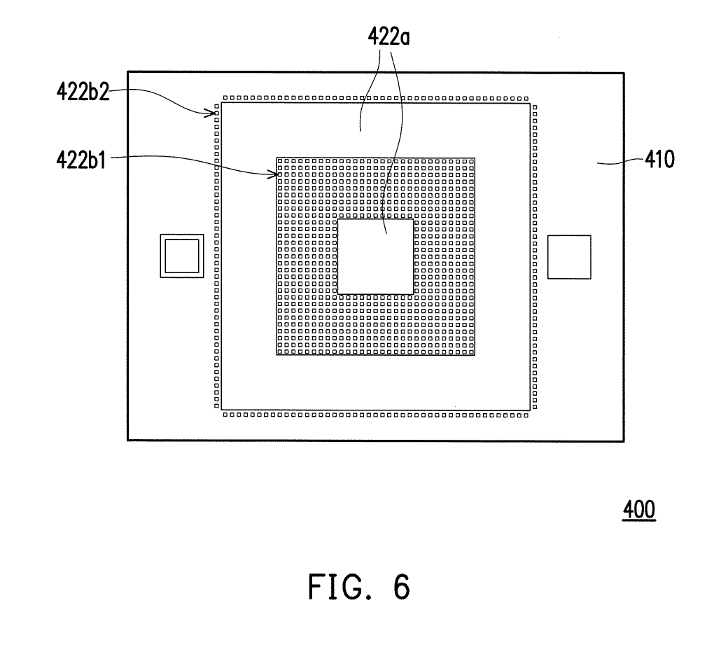

FIG. 4 is a schematic top view of an electro-acoustic transducer according to another embodiment of the invention. FIG. 5 is a schematic cross-sectional view, taken along the line I-I′, of the electro-acoustic transducer of FIG. 4. In an electro-acoustic transducer 300 of FIG. 4 and FIG. 5, a base 310, an opening 312, a vibration portion 320, a piezoelectric transducer layer 322, an upper electrode layer 322a, a piezoelectric material layer 322b, a lower electrode layer 322c, a first hole 322b1, a second hole 322b2, a carrier layer 324, an electrode E3″, an electrode E4″, a trench T″, a first zone Z1′, and a second zone Z2′ are configured and function similar to the base 110, the opening 112, the vibration portion 120, the piezoelectric transducer layer 122, the upper electrode layer 122a, the piezoelectric material layer 122b, the lower electrode layer 122c, the first hole 122b1, the second hole 122b2, the carrier layer 124, the electrode E3, the electrode E4, the trench T, the first zone Z1, and the second zone Z2 of FIG. 1 and FIG. 2 and thus details thereof are not repeated hereinafter.

A difference between the electro-acoustic transducer 300 and the electro-acoustic transducer 100 is that each vibration portion 320 has a first connection end 320a and a second connection end 320b opposite to each other. The first connection ends 320a are connected to the base 310. The electro-acoustic transducer 300 further includes a connection portion 330 that is separated from the base 310 and connects the second connection ends 320b. The connection portion 330 is located in the opening 312. The first connection ends 320a are connected to an inner edge of the opening 312, and the vibration portions 320 surround the connection portion 330. With this configuration, the first connection end 320a and the second connection end 320b of each vibration portion 320 are not free ends, and when an acoustic wave or an electrical signal is received, the first connection end 320a and the second connection end 320b may generate reverse stress.

Thus, AC electrical signals of opposite phases may be inputted to the piezoelectric transducer layer 322 respectively at the first connection end 320a and the second connection end 320b, such that the piezoelectric transducer layer 322 generates strains respectively at the first connection end 320a and the second connection end 320b to drive the vibration portion 320 to vibrate and perform input to the electro-acoustic transducer 300 by differential electrical signals, so as to improve the intensity and accuracy of output of the acoustic wave. Moreover, when the vibration portion 320 receives an acoustic wave and drives the piezoelectric transducer layer 322 to deform, the piezoelectric transducer layer 322 generates a strain and AC electrical signals of opposite phases respectively at the first connection end 320a and the second connection end 320b and performs output by a differential electrical signal so as to improve the intensity and accuracy of output of the electrical signal. Accordingly, the electro-acoustic transducer 100 has favorable electro-acoustic transduction quality.

More specifically, the upper electrode layer 322a includes a first electrode zone E1 and a second electrode zone E2 that are separated from each other. The first electrode zone E1 is aligned with the first connection end 320a and is located in the first zone Z1′, and the second electrode zone E2 is aligned with the second connection end 320b and the connection portion 330 and is surrounded by the second zone Z2′. The first holes 322b1 are located between the first electrode zone E1 and the second electrode zone E2.

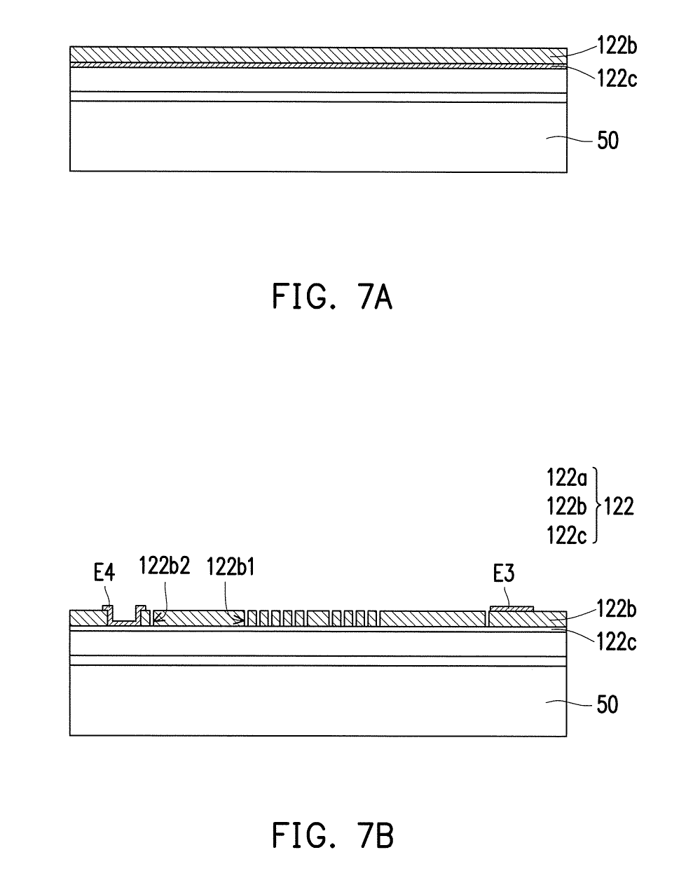

FIG. 6 is a schematic top view of an electro-acoustic transducer according to another embodiment of the invention. In an electro-acoustic transducer 400 of FIG. 6, a vibration portion 420, an upper electrode layer 422a, a first hole 422b1, and a second hole 422b2 are configured and function similar to the vibration portion 120, the upper electrode layer 122a, the first hole 122b1, and the second hole 122b2 of FIG. 1 and thus details thereof are not repeated hereinafter. A difference between the electro-acoustic transducer 400 and the electro-acoustic transducer 100 is that the vibration portion 420 does not have a trench and is a single vibration portion.

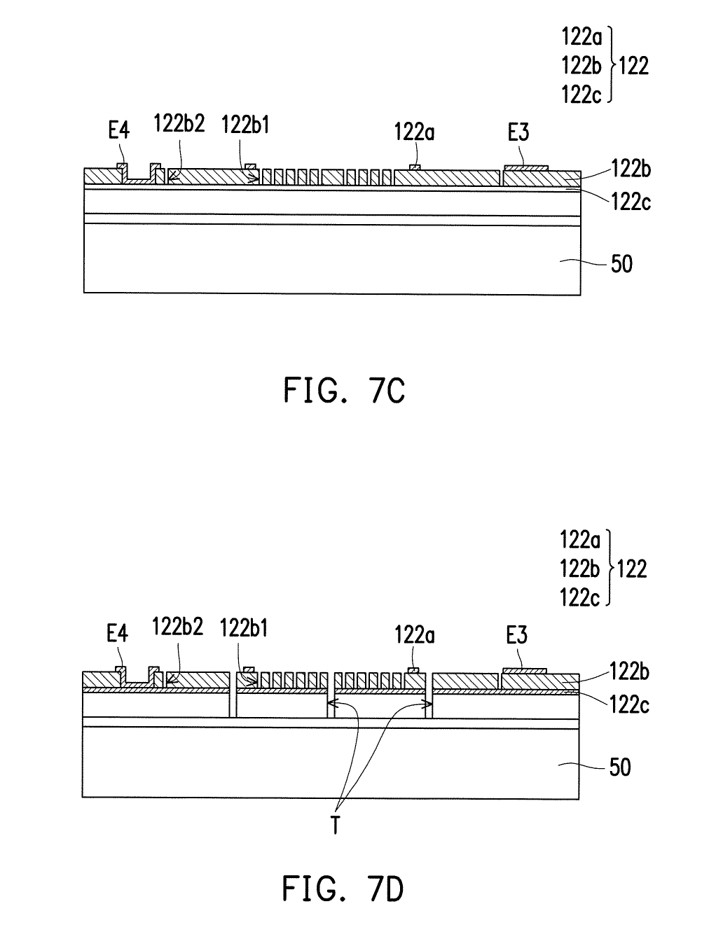

A manufacturing process is described hereinafter based on the electro-acoustic transducer 100 of FIG. 1 as an example. FIG. 7A to FIG. 7D are schematic views illustrating the manufacturing process of the electro-acoustic transducer of FIG. 1, which correspond to the cross-sectional views of the electro-acoustic transducer 100 of FIG. 1 along the line I-I′. First, as shown in FIG. 7A, the lower electrode layer 122c and the piezoelectric material layer 122b are formed on a substrate 50. Then, the first holes 122b1 and the second holes 122b2 are formed on the piezoelectric material layer 122b, as shown in FIG. 7B. As shown in FIG. 7C, the upper electrode layer 122a is fowled on the piezoelectric material layer 122b. The upper electrode layer 122a, the piezoelectric material layer 122b, and the lower electrode layer 122c constitute the piezoelectric transducer layer 122. The upper electrode layer 122a and the lower electrode layer 122c respectively have the electrode E3 and the electrode E4. The upper electrode layer 122a, the electrode E3 of the upper electrode layer 122a, and the electrode E4 of the lower electrode layer 122c are coplanar, for example. As shown in FIG. 7D, the trench T is formed in the substrate 50 and the piezoelectric transducer layer 122, and as shown in FIG. 2, a part of the substrate 50 is removed to define the vibration portion 120 and the extension portion 114. For example, the trench T is formed by a dry etching process, such that the trench T has a smaller width to prevent loss of the acoustic wave via the trench T. Nevertheless, the invention is not limited thereto. The trench T may also be formed by an ion milling process or a deep reactive ion etch (DRIE) process.

To sum up, in the electro-acoustic transducer of the invention, the piezoelectric material layer has a plurality of first holes and the vibration portion may release the residual stress by the first holes to prevent the vibration portion from being unexpectedly permanently deformed and thereby improve the electro-acoustic transduction quality of the electro-acoustic transducer. Moreover, by forming the first holes in the piezoelectric material layer, the weight of the vibration portion may be reduced to increase the amplitude of vibration so as to improve the sensitivity of electro-acoustic transduction. Because the first holes of the piezoelectric material layer are formed in the second zone, instead of the first zone where the upper electrode layer is located, during vibration of the vibration portion, the stress change of the piezoelectric material layer in the first zone is not affected by the first holes, and thus the expected piezoelectric transduction effect is achieved. Moreover, the outermost ones of the first holes of the piezoelectric material layer and the second holes of the piezoelectric material layer form the boundary of the first zone and structurally define the first zone as the stress zone, such that each vibration portion may be expected to perform piezoelectric transduction by the first zone and the upper electrode layer thereon during vibration.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

1. An electro-acoustic transducer, comprising:
a base; and
at least a vibration portion comprising a piezoelectric transducer layer and connected to the base, wherein the piezoelectric transducer layer comprises an upper electrode layer and a piezoelectric material layer, the piezoelectric material layer comprises a first zone and a second zone, at least a part of the upper electrode layer is disposed in the first zone, and the piezoelectric material layer comprises a plurality of first holes in the second zone,
wherein the piezoelectric transducer layer is adapted to receive an electrical signal to deform and drive the vibration portion to vibrate and generate a corresponding acoustic wave, and the vibration portion is adapted to receive an acoustic wave to vibrate and drive the piezoelectric transducer layer to deform and generate a corresponding electrical signal.

2. The electro-acoustic transducer according to claim 1, wherein each of the first holes penetrates the piezoelectric material layer.

3. The electro-acoustic transducer according to claim 1, wherein the second zone is formed into a mesh structure by the first holes.

4. The electro-acoustic transducer according to claim 1, wherein the piezoelectric material layer further comprises a plurality of second holes at a boundary between the vibration portion and the base, and the first zone is located between the first holes and the second holes.

5. The electro-acoustic transducer according to claim 4, wherein each of the second holes penetrates the piezoelectric material layer.

6. The electro-acoustic transducer according to claim 1, wherein the number of the at least a vibration portion is plural, and each of the vibration portions comprises two connection ends and a free end, wherein the connection ends are connected to the base and the free ends are separated from one another.

7. The electro-acoustic transducer according to claim 6, wherein the base comprises an opening, and the vibration portions are located in the opening and the connection ends are connected to an inner edge of the opening.

8. The electro-acoustic transducer according to claim 7, wherein a notch is formed between each of the vibration portions and the inner edge of the opening, and the notch is located between the two connection ends.

9. The electro-acoustic transducer according to claim 8, wherein the base comprises a plurality of extension portions, and the extension portions are connected to the inner edge of the opening and are respectively aligned with the notches and separated from the vibration portions.

10. The electro-acoustic transducer according to claim 6, wherein the upper electrode layer is aligned with the connection end, and the first holes are aligned with the free end.

11. The electro-acoustic transducer according to claim 1, further comprising a connection portion, wherein the number of the at least a vibration portion is plural, and each of the vibration portions comprises a first connection end and a second connection end that are opposite to each other, wherein the first connection ends are connected to the base, and the connection portion is separated from the base and connected to the second connection ends.

12. The electro-acoustic transducer according to claim 11, wherein the base comprises an opening, and the vibration portions and the connection portion are located in the opening, and the first connection ends are connected to an inner edge of the opening.

13. The electro-acoustic transducer according to claim 11, wherein the vibration portions surround the connection portion.

14. The electro-acoustic transducer according to claim 11, wherein the upper electrode layer comprises a first electrode zone and a second electrode zone that are separated from each other, the first electrode zone is aligned with the first connection end and is located in the first zone, the second electrode zone is aligned with the second connection end and the connection portion and is surrounded by the second zone, and the first holes are located between the first electrode zone and the second electrode zone.

15. The electro-acoustic transducer according to claim 14, wherein the first electrode zone is adapted to receive or output an electrical signal and the second electrode zone is adapted to receive or output another electrical signal, and the two electrical signals have opposite phases.

16. The electro-acoustic transducer according to claim 1, wherein the vibration portion further comprises a carrier layer, and the piezoelectric transducer layer is disposed on the carrier layer, wherein the piezoelectric transducer layer is adapted to deform relative to the carrier layer to drive the vibration portion to vibrate, and the vibration portion is adapted to vibrate and drive the piezoelectric transducer layer to deform relative to the carrier layer.

17. The electro-acoustic transducer according to claim 16, wherein a material of the carrier layer is a non-piezoelectric material.

18. The electro-acoustic transducer according to claim 1, wherein the piezoelectric transducer layer further comprises a lower electrode layer, and the piezoelectric material layer is disposed between the upper electrode layer and the lower electrode layer.
